(19) United States
(12) Patent Application Publication
(10) Pub. No.: US 2003/0182912 A1
(43) Pub. Date: Oct. 2, 2003

(54) Mower for attaching onto a carrier machine

(75) Inventor: Ullrich Boll, Bad Saulgau (DE)

Correspondence Address: HUSCH & EPPENBERGER, LLC, 401 MAIN STREET, SUITE 1400, PEORIA, IL, 61602, US

(73) Assignee: CLAAS SAULGAU GmbH

(21) Appl. No.: 10/402,116

(22) Filed: Mar. 28, 2003

(30) Foreign Application Priority Data
Mar. 28, 2002 (DE) 102 14 332.3

(51) Int. Cl. A01D 34/64

(52) U.S. Cl. 56/14.7

(57) ABSTRACT

A mower having mower units for attaching to a carrier machine, comprising mower blades operatively connected to mower gyros which rotate in a circulating motion about predominantly vertical gyro axis and operatively connected to the mower units, a support frame operatively connected to the mower units by movable joints, the mower units capable of being folded at a pivoting device about pivot axis parallel to a direction of travel, wherein the mower unit is moved from a working position to a transporting position and from the transporting position to the working position, and the movable joints are separated from each other by a first distance in the working position and a second distance in the transporting distance, wherein the second distance is substantially larger than the first distance.

### TECHNICAL FIELD OF THE INVENTION

The present invention relates to mower, and more specifically to a mower for attaching onto a carrier machine.

### DESCRIPTION OF THE RELATED ART

Rotary mowers are generally known in the relevant art. Rotary mowers have working devices or mower units with large working widths for cutting green harvests. The mower units are commonly attached to tractors, self-propelled harvesters, etc. One disadvantage to these attached mowers is they extend beyond the widths permissible on public roads. To avoid exceeding permissible widths on public roads, the working devices are moved into a transport position which reduces the width with respect to the working width. Specifically, the mower units are coupled and connected to the carrier machine so that they can be pivoted from the working position into the transporting position and vice versa. The mower units are pivoted into the working position about folding axis which are parallel to the direction of travel or about vertical folding axis by means of actuating drives and folding mechanisms.

German Publication DE 42 25 249 A1 discloses an embodiment of this generic type. A mowing machine having three mower, wherein the two outer mowers are held by a respective pivoting device. The pivoting device provides the means for support between the supporting frame, which is connected to the three-point yoke, and the machine framework of a drum mower or tedder. The pivoting device of each outer mower comprises two links which differ in length and are connected to the machine framework and the supporting frame in joints. The joint points of the links are arranged a distance above the section plane of the mower blades and are aligned with one another in such a manner that straight lines of the connecting lines through the joint axis form an intersecting point which determines the position at a particular instance of an ideal axis of rotation for the mower. This axis of rotation is situated a distance away from and outside the center of the supporting frame.

The present invention is directed to overcoming one or more of the problems set forth above.

### SUMMARY OF THE INVENTION

An aspect of the invention is to provide a mower for attaching onto a carrier machine having mower gyros operatively driven in a circulating manner about predominantly vertical gyro axis, the mower having mower blades and at least two mower units operatively connected to a supporting frame at joints, whereby the mower units have means for pivoting the mower units about pivot axis parallel to a direction of travel from a working position into a transporting position and from the transporting position to the working position, wherein a first distance between the joints while in the transporting position is substantially larger than a second distance between the joints while in the working position.

Another aspect of the invention is a mower having a large working width and a minimal number of foldable mower units while the working width is maximized and the restraining boundary conditions, such as the permissible transporting width and transporting height, are not exceeded.

In yet another aspect of the invention, there is a mower having at least two adjacent mower units, which is distinguished by a framework construction or supporting frame construction having double joints. Joint axis run at a short distance from and parallel to each other in the direction of travel or the joint axis, but the joints are arranged one behind the other in the direction of travel. This mutual arrangement of the joints, referred to as double joint below, is situated in the immediate vicinity of the ground approximately level with the section plane of the mower blades.

In still another aspect of the invention, each mower unit is explicitly assigned a dedicated joint with the result that each mower unit can rotate about the joint axis assigned to it transversely with respect to the direction of travel and following the contour of the ground, independently of the other pivoting movements in each case. The two joints are connected to each other and are fixed to each other at least transversely with respect to the direction of travel approximately in the longitudinal central plane of the carrier machine whereas they are released from each other when being transferred into the transporting position and consequently are at a substantially greater distance from each other. Each mower unit remains operatively connected to the joint assigned to it, and the joints can be designed both as hinge connections and as ball-and-socket-joint connections. Each of the two joints is assigned a supporting arm, the longitudinal extent of which runs essentially in the vertical direction. The supporting arm is designed as a spring strut having a damping element. The damping element is an elastic coupling between the mower units and the supporting frame, and it absorbs shock loads approximately perpendicular with respect to the plane of the carriage way, thereby reducing the size of the shock loads. This improves the adaptation of the mower units to contours of the ground.

In yet another aspect of the invention, double joints are coupled to each other at the lower ends of the supporting arms by a tab connection, which is in engagement in the operating or working position, such that they are in synchronous vertical movement. This contributes to there being no differences in length, which relates to the length of the stubble in the overlapping region of the mower blades of the two inner, mutually facing mower plates of the adjacent mower units. The refinement of the coupling of the mower units to one another in conjunction with the connection of them to the supporting structure by the double joints provides the mower units with an additional degree of freedom in its movement options when traversing obstacles. In the process, the spring characteristics of the spring struts enable vertical acceleration forces to be reduced and thus enable the force amplitudes of the acceleration forces to be kept smaller.

In yet still another aspect of the invention, there is an elastic coupling between the mass of the mower units and the mass of the supporting frame. This is provided by the keeping the supporting frame in a rigid position relative to the carrier machine without unnecessarily constricting the movement clearance of the mower units. The rigid position of the supporting frame relative to the support machine is achieved, for example, by the pistons of the hydraulic cylinders of the lifting mechanism for the coupling device of the mower being clamped hydraulically to the carrier machine by corresponding shut-off valves. The elastic coupling is brought about, for example, by spring relief or hydraulic spring suspension by means of a bubble accumulator in conjunction with the rigid articulation of the supporting frame relative to the carrier machine. Thus, the mass of the supporting frame, and therefore its weight, is supported by the carrier machine in each position of the operating or working position and is, therefore, not supported relative to the ground by the mower unit. This is an advantage because it minimizes the ground bearing pressure of the mower unit, which protects the grass hub. This type of articulation prevents constraining forces in the double joints, which can be caused by rolling movements of the carrier machine. These forces are supported by the mower units relative to the ground.

In still another aspect of the invention, the individual mower units are additionally guided on booms which are variable in length, so as to relieve the double joints while in the working position. The booms are designed, for example, as telescopic booms which are connected to the supporting frame in a manner such that they can pivot about horizontal axis. This configuration of the articulation of the booms on the supporting frame and on the mower units improves the pivotability of the mower units about the associated joint axis of the double joint, which in turn improves the improved ground adaptation characteristics. The supporting arms are operatively connected in an articulated manner to the supporting framework, so that they are likewise connected pivotably to the supporting framework. However, the supporting arms are locked relative to the supporting framework when the mower units are in the working position. However, in the locked position, the support arms are locked in placed out of action for the transfer into the transporting position and also during the road transportation itself. This means that the supporting arms have a completely different function in the transporting position than in the working position. The supporting arms act as links, e.g., a link-type coupling, in the transporting position and during the transfer from the working position into the transporting position and vice versa. Thus, the supporting arms have an effect on the folding process by being part of the kinematics control of the foldable pivoting process. They transfer the mower units into a transporting position. In this case, the mower units are held and guided during road transportation in a secure, safe and free-swinging position without an additional lock. The multifunctional configuration of the articulation of the mower units on the supporting frame therefore has, in particular, the following advantages: a) articulated connection of the mower units transversely with respect to the direction of travel in the double joint for adaptation to the ground; b) releasability of the connection of the double joints to one another without the actual articulated connection between the mower and supporting frame being released; c) link-type function of the supporting arms for transfer of the mower units into the transporting position; d) shifting of the articulated connection between the supporting arm and mower unit during the folding process into the outer region of the folded-up mower into the transporting position; e) locking the mower units into the transporting position to preclude swinging movements due to the articulation of the supporting arms; f) elastic coupling between the mower units and supporting frame by the supporting arms as spring struts and thereby improved adaptation to the ground perpendicular with respect to the plane of the carriage way, together with damping function; g) lowering the transporting height by changing the length of the booms using the force of gravity; h) central articulated connection, engaging in the center of gravity, of the booms to a portal frame built over the mower unit in order to improve the adaptation to the ground transversely with respect to the direction of travel; and i) pivotable connection of the mower units to their portal frame in the vicinity of the ground and thereby improved adaptation of the mower units to the ground in the direction of travel.

These and other features, aspects and advantages of the present invention will become better understood with regard to the following detailed description, appended claims and accompanying drawings. The above listing of aspects of the invention should not be deemed as all-inclusive in any manner whatsoever.

### BRIEF DESCRIPTION OF THE DRAWINGS

Reference is now made to the drawings, which illustrate the best known mode of carrying out the invention and wherein the same reference characters indicate the same or similar parts throughout the views.

FIG. 1 shows a mower in a working position in a view counter to a direction of travel;

FIG. 2 shows a side view of a mower in the working position;

FIG. 3 shows a top view of a mower in a transporting position;

FIG. 4 shows an enlarged detail of the articulation of the mower on a supporting frame in the working position;

FIG. 4a shows an enlarged view of the supporting arms according to FIG. 4 which are articulated on the mower units and on the supporting frame;

FIG. 4b shows a longitudinal section as a subsection through the supporting arms according to FIG. 4a;

FIG. 5 shows a mower in the working position adapted to a sloping contour of the ground;

FIG. 6 shows an enlarged view of a double joint according to FIG. 1;

FIG. 7 shows a cross-section B-B according to FIG. 6; and

FIG. 8 shows a section C-C according to FIG. 7.

### DETAILED DESCRIPTION

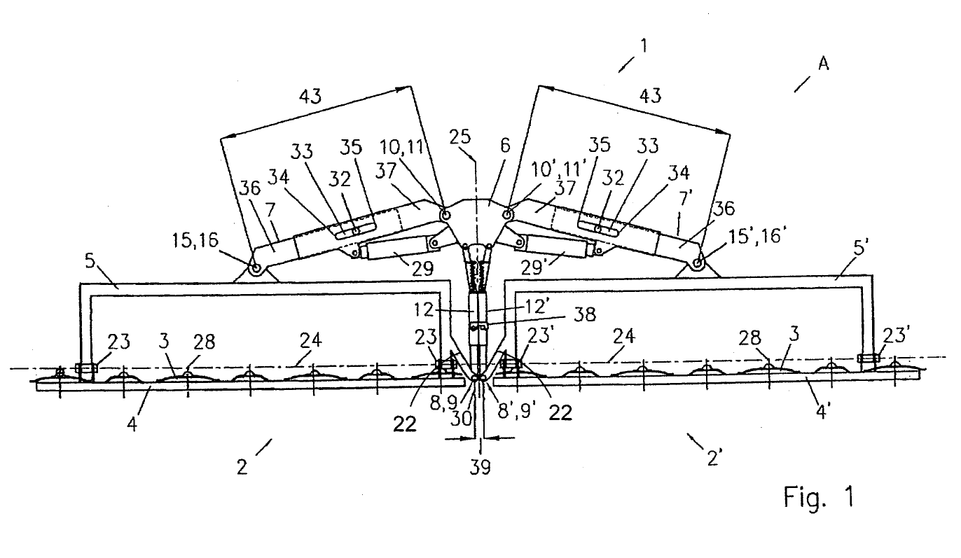

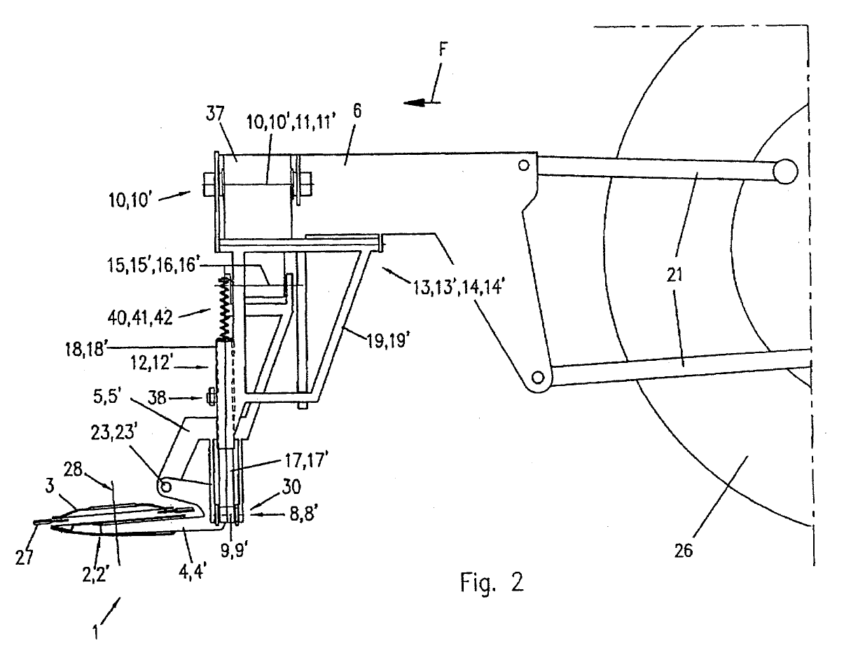

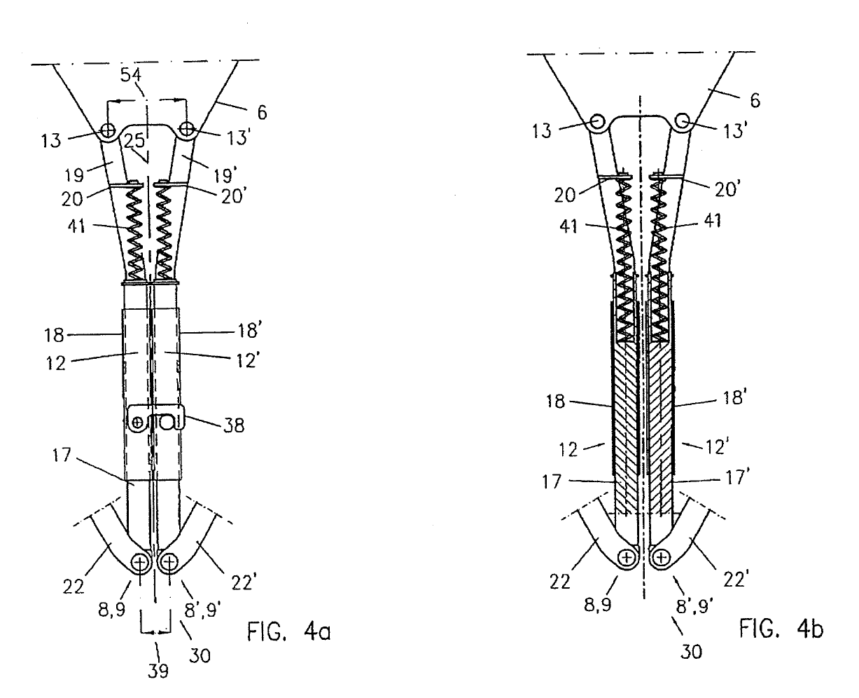

A mower 1 according to the invention is illustrated in a working position A in a view counter to a direction of travel F in FIG. 1. The mower 1 has a tedder with two unfolded mower units 2, 2′. The two mower units 2, 2′ are aligned parallel and horizontally to the ground. FIG. 5 shows the mower 1 with the mower unit 2 in a angled position to follow a sloping contour of the ground. The two mower units 2, 2′ have mower gyros 3. Referring now to FIG. 2, FIG. 2 is a side view according to FIG. 1 of the mower 1 coupled to three-point hydraulics 21 of a carrier machine 26. The mower gyros 3 are driven approximately perpendicular to gyro axis 28 and are fitted with mower blades 27. The mower gyros 3 and mower blades 27 are mounted in gearboxes 4, 4′. Above the gearboxes 4, 4′ are portal frames 5, 5′, the portal frames 5, 5′ are operatively connected to the gearboxes 4, 4′ via horizontal joints 23, 23′ such that they pivot about pivot axis 24. Further, the mower units 2, 2′ are connected to each other about pivot axis 9, 9′, which are approximately parallel to the direction of travel F, by means of joints 8, 8′ at ends of a continuation of the frame 22, 22′. The mower units 2, 2′ are operatively connected supporting frame 6 via booms 7, 7′. The booms 7, 7′ are operatively connected to the supporting frame 6 via support joints 10, 10′ having support axis 11, 11′ and operatively connected to the portal frame 5, 5′ via frame joints 15, 15′ having frame axis 16, 16′. The support axis 11, 11′ and the frame axis 16, 16′ are parallel to the direction of travel F. The supporting frame 6 is coupled, for example, to the three-point hydraulics 21 of a tractor or the carrier machine, such that the mower 1 can be driven by a power take-off shaft of said tractor or carrier machine.

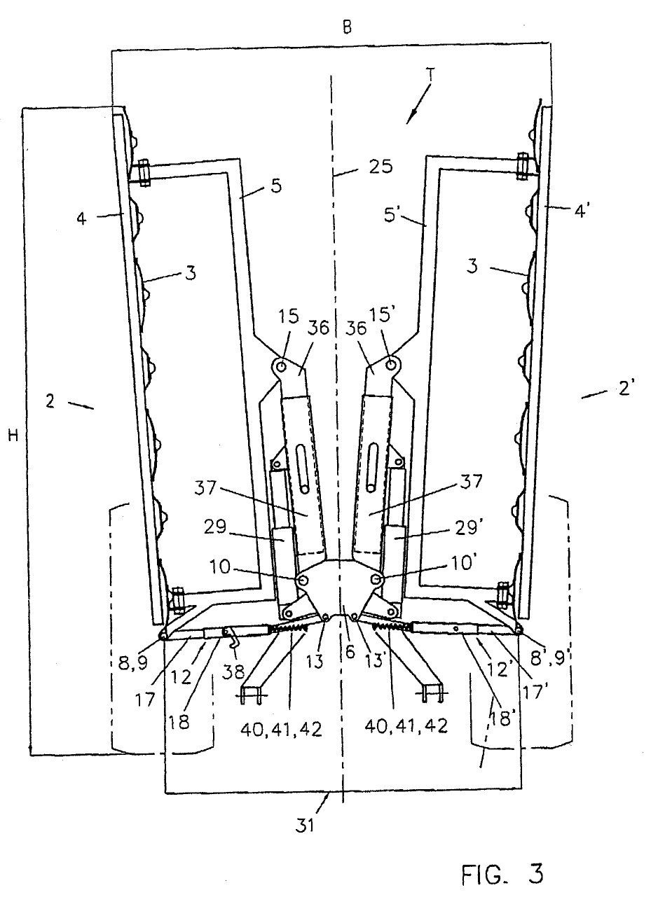

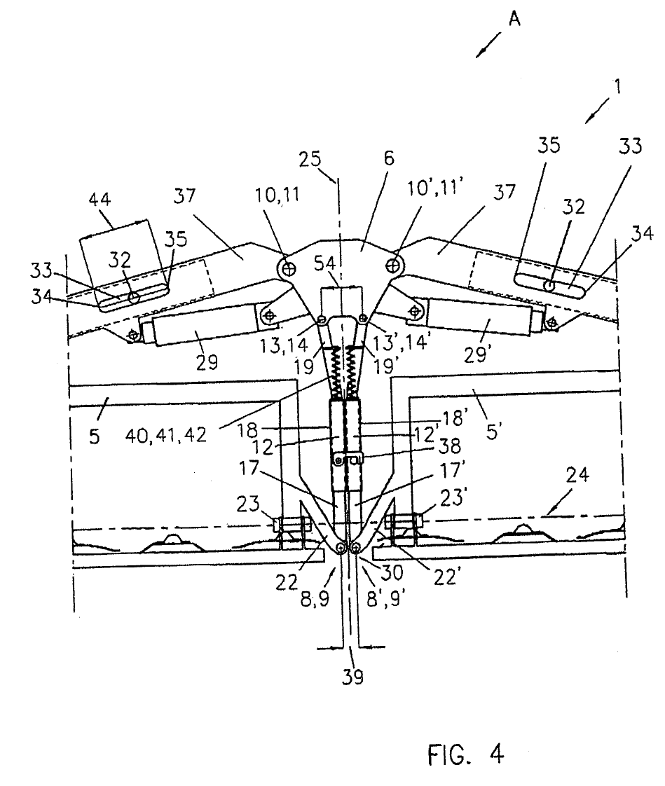

FIG. 3 shows the mower 1 in a transporting position T having a transporting width B. In the transporting position T, the mower units 2, 2′ are folded upwardly. A locking device 38 is unlocked to allow the mower 1 and the joints 8, 8′ to be released from each other at the beginning of the folding process. During the movement to the transporting position T, the joints 8, 8′ are moved from a vertical central plane 25 of the mower 1 into an outer region of the folded-up mower 1. At this point, the mower units 2, 2′ are in vertical alignment relative to a standing surface of the carrier machine 26, and the longitudinal displaceability of the booms 7, 7′ provide additional lowering of the mower units 2, 2′ relative to the standing surface of the carrier machine 26, which reduces a transporting height H.

The mower 1 is symmetrically with respect to the central plane 25, which is approximately the central plane of the carrier machine 26. The supporting frame 6 is arranged centrally between the two mower units 2, 2′ with the supporting arms 12, 12′ articulated at a distance 54 from each other on front joints 13, 13′. Movable joints 8, 8′ are situated at free ends of the supporting arms 12, 12′. The movable joints 8, 8′ operatively connect the portal frames 5, 5′ below the pivot axis 24, which connects the mower units 2, 2′ to each other. The supporting arms 12, 12′ have inner parts 17, 17′ aligned approximately perpendicular with respect to the ground in the working position A. In the preferred embodiment, the inner parts 17, 17′ are prism-shaped. The movable joints 8, 8′ are operatively connected to ends of the inner parts 17, 17′ and facing the ground. The movable joints 8, 8′ are a double joint 30 with each other, with respective mower units 2, 2′ being articulated on each of the movable joint 8, 8′ in such a way that they can pivot about horizontal axis 9, 9′ which are parallel to the direction of travel T. The inner parts 17, 17′ are guided in a vertically displaceable manner by an outer part 18, 18′ which are used as containing guides. The outer parts 18, 18′ have extension parts 19, 19′ which are connected upper ends to the supporting frame 6 via the front joints 13, 13′. The extension parts 19, 19′ are pivotably mounted about axis 14, 14′, which are parallel to the direction of travel F.

In the preferred embodiment, the supporting arms 12, 12′ have spring relief and damping elements 40. The damping element 40 permits changes in length of the supporting arms 12, 12′ because of the vertical forces acting on the supporting arms 12, 12′. The function of the supporting arms 12, 12′ are similar to the function of a spring strut. The spring elements may be, for example, gas-filled compression springs and/or in conjunction with shock absorbers. The supporting arms 12, 12′ may be hydraulic cylinders and the inner parts 17, 17′ may be piston rods and the cylinder housings may be outer parts 18, 18′ and hence as containing guides. The piston rods can be clamped hydro-statically by hydraulic accumulators resulting in the elastic coupling and damping, for example, by the hydraulic accumulators designed as pneumatically pre-stressed bubble accumulators.

In the preferred embodiment, the inner parts 17, 17′ of the supporting arms 12, 12′ are supported relative to the supporting frame 6 in abutments 20, 20′ via pre-stressed compression springs 42. The support takes place indirectly via the front joints 13, 13′ because the abutments 20, 20′ are a fixed part of the extension parts 19, 19′ and are therefore also a fixed part of the outer parts 18, 18′. The supporting arms 12, 12′ are connected to each other in the working position A by the locking units 38, with the result that the pivotability of the supporting arms 12, 12′ about the front joints 13, 13′ is precluded. As a result, mutual distance 39 between the movable joints 8, 8′ is virtually constant, so that in this state the movable joints 8, 8′, which are functionally coupled to each other, form the double joint 30.

First ends of the booms 7, 7′ are fastened in the movable joints 8, 8′ of the portal frame 5, 5′ approximately in the center of its center of gravity. The second ends of the booms 7, 7′ are connected to the supporting frame 6 in the joints 10, 10′. The joint axis 9, 9′ and 11, 11′ of the movable joints 8, 8′ and the support joints 10, 10′, respectively, are aligned as folding axis predominantly parallel to the direction of travel F. The hydraulic cylinders 29, 29′ serve as actuating drives for folding the mower units 2, 2′ into the transporting position T.

In the preferred embodiment, the booms 7, 7′ are telescopic booms to provide a change in length of the booms 7, 7′ during operation. This change in length is limited by outer and inner stop surfaces 34, 35 of slots 33 in which the stop bolts 32, which are connected to the inner tubes 36 of the booms 7, 7′, are guided. This slotted guide therefore permits adaptation to the ground transversely with respect to the direction of travel F and contributes to reducing the damage when traversing obstacles. The capability of the booms 7, 7′ to change in length also serves for guiding the mower units 2, 2′ in a constraint-free manner with respect to the movable joints 8, 8′ and the horizontal forces transversely with respect to the direction of travel F.

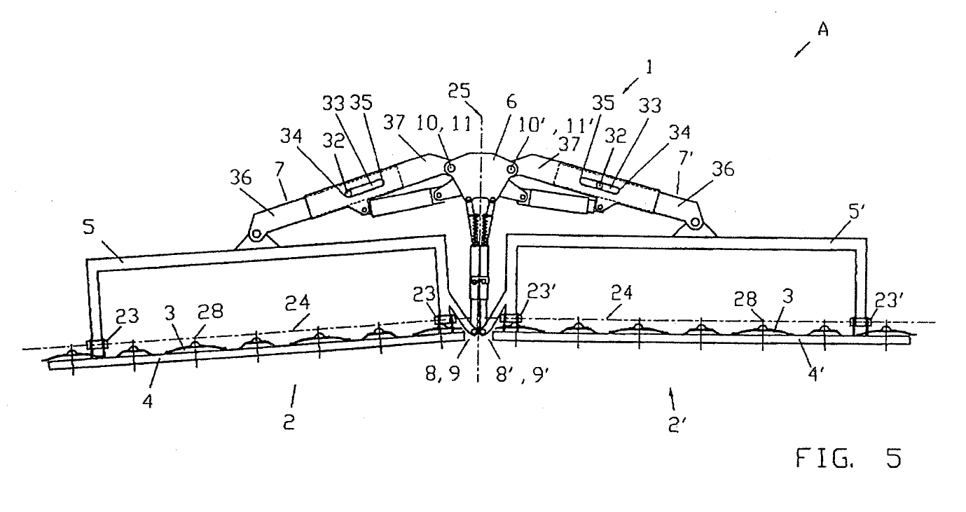

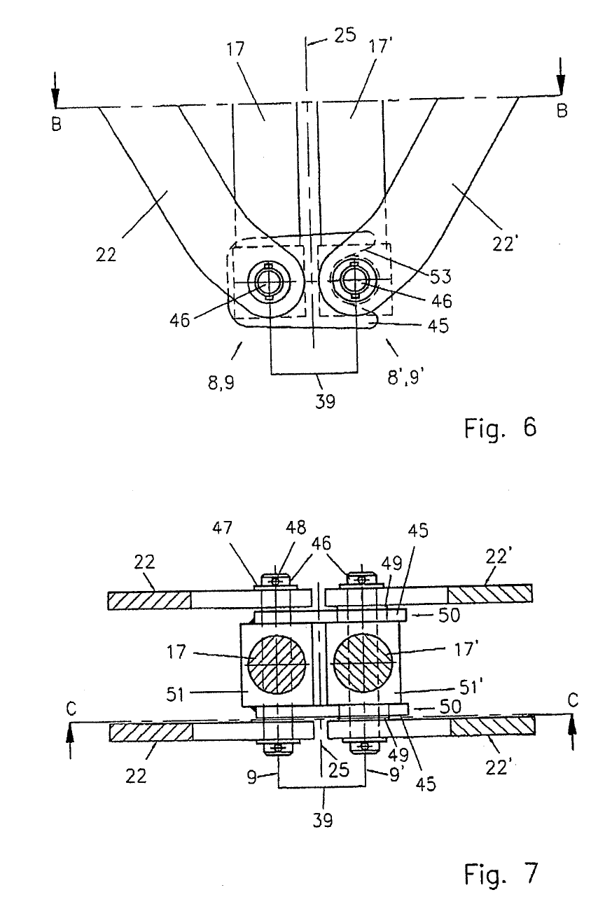

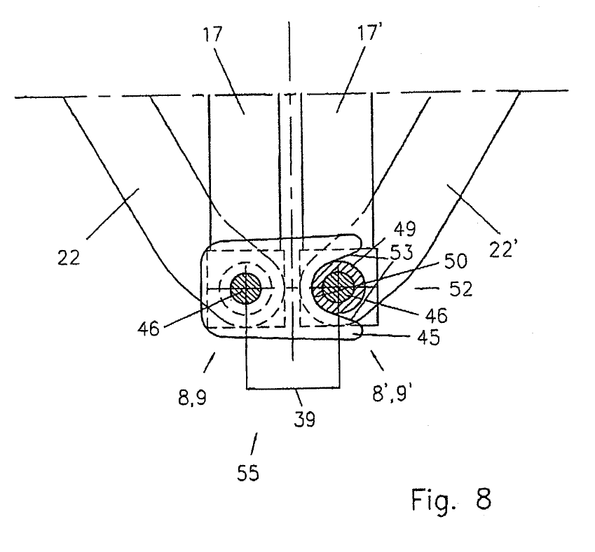

When the booms 7, 7′ are pivoted into the transporting position T, the locking device 38 is unlocked and the hydraulic cylinders 29, 29′ are pressurized to allow the booms 7, 7′ to pivot about the pivot axis 11, 11′ in the support joints 10, 10′. In the transporting position T, the booms 7, 7′ are moved toward each other to form a block owing to the gravitational force with the result that the transporting height H of the mower 1 is thereby reduced. This structural feature contributes to minimizing the transporting height H in the transporting position T and to maximizing the working width in the working position A. The hydraulic cylinders 29, 29′ can be designed as cost-effective plunger cylinders. The mower units 2, 2′ are transferred from the working position A into their transporting position T by the booms 7, 7′ being pivoted (i.e. folded upward) about the pivot axis 11, 11′, which face the supporting frame 6. The mower units 2, 2′ are guided kinematically by the supporting arms 12, 12′ as coupling elements to the portal frame 5, 5′ as part of the framework construction in such a manner that the mower units 2, 2′ are not only connected to the pivoting movement of the booms 7, 7′ themselves, but also in such a manner that the supporting arms 12, 12′ now take on the function of the link-type coupling with respect to the mower units 2, 2′. As a result, the mower units 2, 2′ undergo an additional rotation about their respective pivot axis 16, 16′ in the respective frame joints 15, 15′ while being folded upward into the transporting position T. The mower units 2, 2′ are transferred into an optimum position with regard to the transporting width when moved into the transportation position T. The supporting arms 12, 12′ prevent the mower units 2, 2′ from swinging about the pivot axis 16, 16′ of the frame joints 15, 15′ while the supporting arms 12, 12′ constitute a transporting lock for the mower units 2, 2′ because of the articulation in the transporting position T and during road transportation. The locking device 38 may be implemented manually or by actuation, for example, by a hydraulic cylinder. For example, a locking device 38 may also be realized by the front joints 13, 13′ being spanned relative to the supporting frame 6 by hydraulic cylinders. The movable joints 8, 8′ may be designed as hinge joints or ball-and-socket joints. The double joint includes the movable joints 8 and 8′ as shown in detail in FIGS. 6-8. FIG. 6 shows an enlarged view of the double joint according to FIG. 1; FIG. 7 shows a cross-section at B-B according to FIG. 6; and FIG. 8 shows section C-C according to FIG. 7. The movable joints 8, 8′ are situated at lower ends of the inner parts 17, 17′ of the supporting arms 12, 12′ with respective bearing collar 51, 51′ of the movable joints 8, 8′ operatively attached to the respective inner part 17, 17′.

Joint bolt 46 lies in the pivot axis 9, 9′ and penetrates both the bearing collar 51, 51′ and the continuations 22, 22′ of the portal frame 5, 5′ and form the movable joint 8, 8′. The joint bolt 46 is axially fixed via washers 47 and clamping sleeves 48. A centering stop 50 is welded to the bearing collar 51 on both sides. The centering stop 50 has a centering opening 53 which faces the adjacent movable joint 8′. The bearing collar 51′ has, on both sides, a centering projection 49 which, in the working position A, is supported on the stop surface as a centering stop 50. As a result, the mutual distance 39 between the movable joints 8, 8′ is secured and locked in conjunction with the locking device 38. This configuration of the bearing collar 51, 51′ in conjunction with the driver tab 45 constitutes the vertical connection and hence a vertical lock 55 of the movable joints 8, 8′ and the vertical connection of the inner parts 17, 17′ to each other. The movable joints 8, 8′ in conjunction with the horizontal locking device 38 and the vertical lock 55, designed as a driver tab 45, thus constitute a double joint in the form of a structural and functional unit. However, for the transfer of the mower 1, the locking device 38 and vertical lock 55 have to be released again, since it is otherwise not possible to fold the mower 1 into the favorable transporting position T as a result of which the distance 39 between the movable joints 8, 8′ in the transporting position T can be considerably enlarged in comparison with the working position A. The actual joint connections of the movable joints 8, 8′ are functionally retained and take on a significant function with regard to the link-type coupling for controlling the pivoting process of the mower units 2, 2′ about the respective pivot axis 16, 16′ of the frame joints 15, 15′ so as to transfer the mower 1 into a particularly favorable transporting position T. In an alternative embodiment, the movable joints 8, 8′ can be arranged next to each other in the direction of travel F and one behind the other in the direction of travel F. The distance 39 between the movable joints 8, 8′ in the working position A would disappear or be reduced to zero (i.e. the pivot axis lie in one and the same axis). The same is also true in a similar manner for the supporting arms 12, 12′ which can also be arranged one behind the other in the direction of travel F and in which then the joints front 13, 13′ can also be arranged one behind the other. In the latter case, the pivot axis 14, 14′ would then also be situated one behind the other and the distance 39 between the front joints 13, 13′ would disappear or be reduced to zero (i.e., the pivot axis would lie in one and the same axis). In each case, the joint connection to the supporting arms 12, 12′ and the joint connection 8, 8′ to the supporting arms 12, 12′ is also retained and thus so too is the mechanical connection between the respective mower units 2, 2′ and the supporting arms 12, 12′ in the transporting position T (i.e., this connection takes on an important locking function with regard to a stable arid therefore travel-safe position of the mower units 2, 2′ during road transportation. The articulated connection of the mower unit 2, 2′ to the portal frames 5, 5′ contributes to a further improvement in the adaptation of the mower units 2, 2′ to the ground with regard to the direction of travel F by the pivotability of the mower units 2, 2′ about joint axis 24 enabling an improvement in the traversing of bumps, humps and elevations or the driving through of valleys or dips in the terrain by the possible deflection and adaptation of the mower units 2, 2′ to the contour of the ground. Depending on the design on the movable joints 8, 8′, the distance between the movable joints 8, 8′ is preferably in a range of from approximately 0 to 150 mm.

It is furthermore ensured by the mower units 2, 2′ being articulated close to the ground on the supporting frame 6 in the movable joints 8, 8′, that the mower blades 27 of the adjacent mowers 2, 2′ do not come into mutual contact in the region of the central plane 25 and therefore in an overlapping region. This is a unique method for transferring a mower from its maximum working position A into a particularly favorable transporting position T and vice versa. A method for pivoting the mower 1 is by attaching the mower onto the carrier machine 26 having mower gyros 3 driven in a circulating motion about predominantly vertical gyro axis and occupied by mower blades 27 and having at least two mower units 2, 2′ operatively connected to the supporting frame 6 at movable joints 8, 8′ such that the movable joints 8, 8′ can be folded by the pivoting device about pivot axis 11, 11′ parallel to the direction of travel F from the working position A into the transporting position T and vice versa, wherein the mower units 2, 2′ are operatively connected to each other via the movable joint 8, 8′ in each case, the movable joints 8, 8′ being moveable relative to each other and, irrespective of their position at a particular instance, permitting the mower units 2, 2′ to pivot about the respective movable joints 8, 8′.

What is claimed is:

1. A mower having mower units for attaching to a carrier machine, comprising:
mower blades operatively connected to mower gyros which rotate in a circulating motion about predominantly vertical gyro axis and operatively connected to the mower units;
a support frame operatively connected to the mower units by movable joints, the mower units capable of being folded at a pivoting device about pivot axis parallel to a direction of travel, wherein the mower unit is moved from a working position to a transporting position and from the transporting position to the working position; and
the movable joints are separated from each other by a first distance in the working position and a second distance in the transporting distance, wherein the second distance is substantially larger than the first distance.

2. A mower having mower units for attaching to a carrier machine, comprising:
mower gyros rotatably driven in a circulating movement about predominantly. vertical gyro axis and occupied by mower blades;
a supporting frame operatively connected to the mower units at movable joints;
the mower units pivotable about the movable joints for folding the mower units about pivot axis parallel to a direction of travel from a working position into a transporting position and from the transporting position to the working position;
the movable joints movable relative to each other during pivoting of the mower units permitting the mower units to pivot about their respective movable joint independent of each other.

3. The mower having mower units for attaching to a carrier machine according to claim 1, wherein the movable joints located in a central plane of the carrier machine when the mower units are placed in the working position and located in an outer region when the mower units are folded up to the transportation position.

4. The mower having mower units for attaching to a carrier machine according to claim 3, further including:
supporting arms having lower ends operatively attached to the mower units;
a supporting frame operatively attached to the support arms and the mower units; and
the supporting arms articulating on the supporting frame via the movable joints when moved into the working position.

5. The mower having mower units for attaching to a carrier machine according to claim 4, further including:
a locking device for releasably connecting the supporting arms to each other.

6. The mower having mower units for attaching to a carrier machine according to claim 4, further including:
booms having first ends that are pivotable about support joints, the support joints operatively connected between the support frame and the first ends of the booms.

7. The mower having mower units for attaching to a carrier machine according to claim 6, further including:
frame joints having pivot axis at approximately centers of the mower units; and
the mower units articulating at a second end of the booms via the frame joints about the pivot axis.

8. The mower having mower units for attaching to a carrier machine according to claim 7, further including:
portal frames having a center of gravity and containing the mower units; and
the frame joints articulating at the center of gravity of the portal frame.

9. The mower having mower units for attaching to a carrier machine according to claim 8, wherein the first distance in the working position is variable in length.

10. The mower having mower units for attaching to a carrier machine according to claim 9, wherein lengths of the booms are variable telescopically.

11. The mower having mower units for attaching to a carrier machine according to claim 10, further including stops including inner and outer stops for precluding the booms from moving beyond the stops.

12. The mower having mower units for attaching to a carrier machine according to claim 11, further including hydraulic cylinders for folding the mower units into the transporting position from the working position.

13. The mower having mower units for attaching to a carrier machine according to claim 12, wherein the hydraulic cylinders are plunger cylinders.

14. The mower having mower units for attaching to a carrier machine according to claim 11, the supporting arms are operatively arranged parallel to each other in the direction of travel.

15. The mower having mower units for attaching to a carrier machine according to claim 11, wherein the supporting arms are arranged one behind the other relative to the direction of travel.

16. The mower having mower units for attaching to a carrier machine according to claim 11, wherein the front joints are arranged at a distance adjacent each other relative to the direction of travel.

17. The mower having mower units for attaching to a carrier machine according to claim 11, wherein the front joints are arranged offset one behind the other relative to the direction of travel.

18. The mower having mower units for attaching to a carrier machine according to claim 11, wherein the pivot axis of the front joints are in a row one behind the other.

19. The mower having mower units for attaching to a carrier machine according to claim 11, wherein the movable joints are arranged adjacent each other relative to the direction of travel.

20. The mower having mower units for attaching to a carrier machine according to claim 11, wherein the movable joints are arranged offset one behind the other relative to the direction of travel.

21. The mower having mower units for attaching to a carrier machine according to claim 11, wherein the pivot axis of the front joints are in a row one behind the other.

22. The mower having mower units for attaching to a carrier machine according to claim 11, wherein the movable joints are spaced between 0 mm to 150 mm when in the transporting position.

23. The mower having mower units for attaching to a carrier machine according to claim 5, wherein the movable joints are secured in the working position with by the locking device.

24. The mower having mower units for attaching to a carrier machine according to claim 5, wherein the movable joints are secured in the working position with regard to their vertical position at a particular instance with respect to each other.

25. The mower having mower units for attaching to a carrier machine according to claim 11, wherein the mower units are fixed in the transporting position and the supporting arms are pivotable about via the movable joints.

26. The mower having mower units for attaching to a carrier machine according to claim 25, wherein the supporting arms have pre-stressed damping elements.

27. The mower having mower units for attaching to a carrier machine according to claim 26, wherein the pre-stressed damping elements are spring elements.

28. The mower having mower units for attaching to a carrier machine according to claim 27, wherein the damping elements are pre-stressed compression springs.

29. The mower having mower units for attaching to a carrier machine according to claim 25, wherein the supporting arms are hydraulic cylinders.

30. The mower having mower units for attaching to a carrier machine according to claim 27, wherein the damping elements are pre-stressed, hydro-pneumatic gas-filled compression springs.

31. The mower having mower units for attaching to a carrier machine according to claim 27, wherein the damping elements are pre-stressed gas-filled compression springs and a shock absorber.

32. The mower having mower units for attaching to a carrier machine according to claim 8, wherein the mower units are operatively connected to the portal frame and the mower units pivotable about pivot axis proximate the ground.

33. A method for pivoting mower units in a mower attached to a carrier machine, the comprising the steps of:
folding the mower units via a pivoting device about pivot axis parallel to a direction of travel;
pivoting the mower units from a working position to a transporting position;
pivoting the mower units from the transporting position to the working position; and
moving the mower units about movable joints independently from each other.

34. The method for pivoting mower units in a mower attached to a carrier machine according to claim 1, further comprising the steps of:
moving the movable joints to a central plane of the carrier machine when the mower units are placed in the working position; and
moving the movable joints to an outer region when the mower units are folded up to the transportation position.
